(19) United States
(12) Patent Application Publication
(10) Pub. No.: US 2016/0095170 A1
(43) Pub. Date: Mar. 31, 2016

(54) PAPER COOKWARE

(71) Applicant: JANE SUNGHEE KIM, Beaumont, CA (US)

(72) Inventor: JANE SUNGHEE KIM, Beaumont, CA (US)

(21) Appl. No.: 14/499,620

(22) Filed: Sep. 29, 2014

(51) Int. Cl. H05B 6/12; A47J 36/02; A47J 36/04; H05B 6/36; A47J 27/00

(52) U.S. Cl. CPC H05B 6/1209; H05B 6/362; A47J 27/002; A47J 36/04; A47J 36/022

(57) ABSTRACT

The paper cookware includes a paper pot made from a sheet to form a pot shape, a support member for structurally supporting the paper pot, and an induction interface disk placed on the bottom portion of the paper pot. The induction interface disk is made of a metal susceptible to being inductively heated with high frequency magnetic induction fields. The sheet includes a first outer layer, a second outer layer, and an inner layer. The inner layer is fabricated with silicone or water impermeable plastics. The induction interface disk comprises a plurality of holes and spikes. The spikes are formed on a bottom surface of the induction interface disk resting on the bottom portion of the paper pot.

### FIELD OF THE INVENTION

The present invention relates to a paper cookware for use in induction heating, and more particularly, to a disposable paper cookware for use in induction heating and for cooking shabu shabu.

### BACKGROUND OF THE INVENTION

The present invention relates to a disposable paper cookware for use in induction heating and for cooking shabu shabu. The conventional shabu shabu cookware or pot is generally made of metal and oftentimes even the handles are also made of metal. Even when an induction heating is used, the shabu shabu cookware or pot is generally made of metal. Accordingly, during the cooking process, the pot and handles become very hot and handling of the pot becomes difficult. Even after the cooking, the pot is still very hot for a while, and it has to be cooled before being washed and cleaned.

Accordingly, to solve the above problems, a need for a disposable paper cookware for use in induction heating and for conveniently cooking shabu shabu has been present for a long time considering the expansive demands in the everyday life. This invention is directed to solve these problems and satisfy the long-felt need.

### SUMMARY OF THE INVENTION

The present invention contrives to solve the disadvantages of the prior art. The present invention provides a disposable paper cookware for use in induction heating. This invention is especially suitable for cooking shabu shabu.

An object of the present invention is to provide a disposable paper cookware which includes a paper pot made from a sheet to form a pot shape, a support member for structurally supporting the paper pot, and an induction interface disk placed on the bottom portion of the paper pot. The induction interface disk is made of a metal susceptible to being inductively heated with high frequency magnetic induction fields.

Another object of the present invention is to provide a disposable paper cookware which includes a paper pot made from a sheet to form a pot shape, a support member for structurally supporting the paper pot, and an induction interface disk placed on the bottom portion of the paper pot. The sheet includes a first outer layer, a second outer layer, and an inner layer. The inner layer is fabricated with silicone or water impermeable plastics.

Still another object of the present invention is to provide a disposable paper cookware which includes a paper pot, a support member, and an induction interface disk placed on the bottom portion of the paper pot. The induction interface disk comprises a plurality of holes and spikes. The spikes are formed on a bottom surface of the induction interface disk resting on the bottom portion of the paper pot.

The advantages of the present invention are: (1) the disposable paper cookware of the present invention is for use in induction heating and for cooking shabu shabu; (2) the disposable paper cookware of the present invention is light weight, safe, and easy and inexpensive to manufacture; (3) the paper pot is disposable and convenient to use because once the paper cookware is used, the used paper pot is disposed and a new one is used, and the supporting member and the disk are cleaned and used again; (4) the support member of the present invention is thermally insulating and facilitates easy handling during the cooking process.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a perspective view of the paper cookware according to the present invention;

FIG. 2 shows the induction interface disk placed on the bottom of the paper pot;

FIG. 3(a) shows the paper pot;

FIG. 3(b) shows a sectional view of the sheet;

FIG. 4 shows a perspective view of the support member;

FIG. 5(a) shows a top perspective view of the induction interface disk; and

FIG. 5(b) shows a bottom perspective view of the induction interface disk.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the term “or” is used to refer to a nonexclusive or, unless otherwise indicated. Moreover, unless explicitly stated to the contrary, embodiments “comprising” or “having” an element or a plurality of elements having a particular property may include additional such elements not having that property.

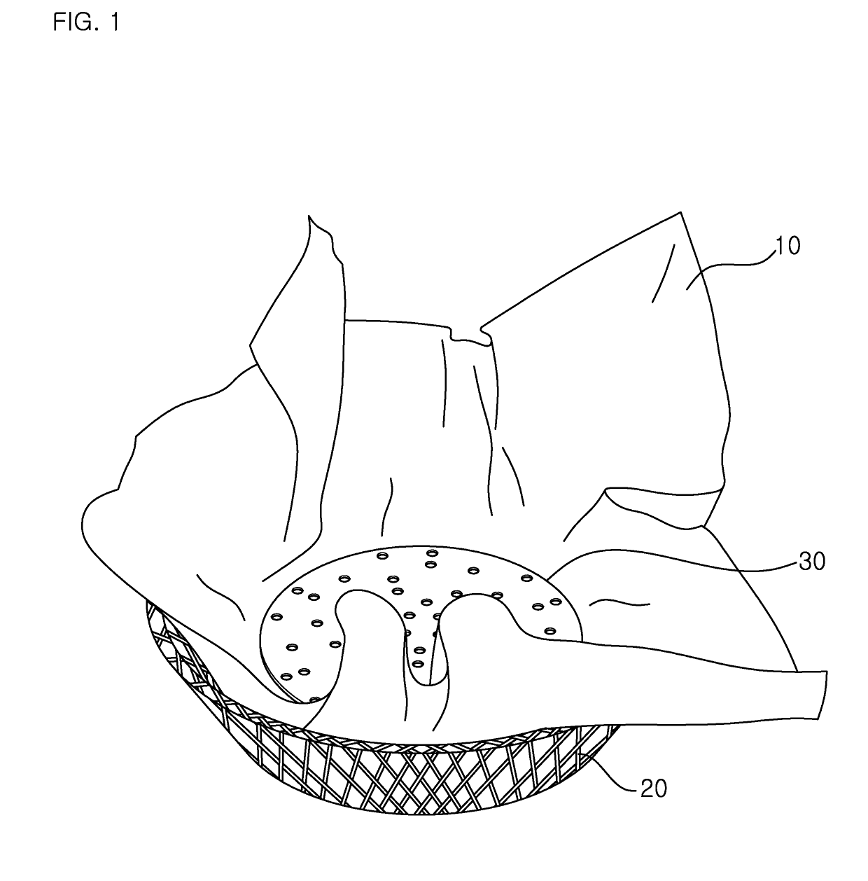

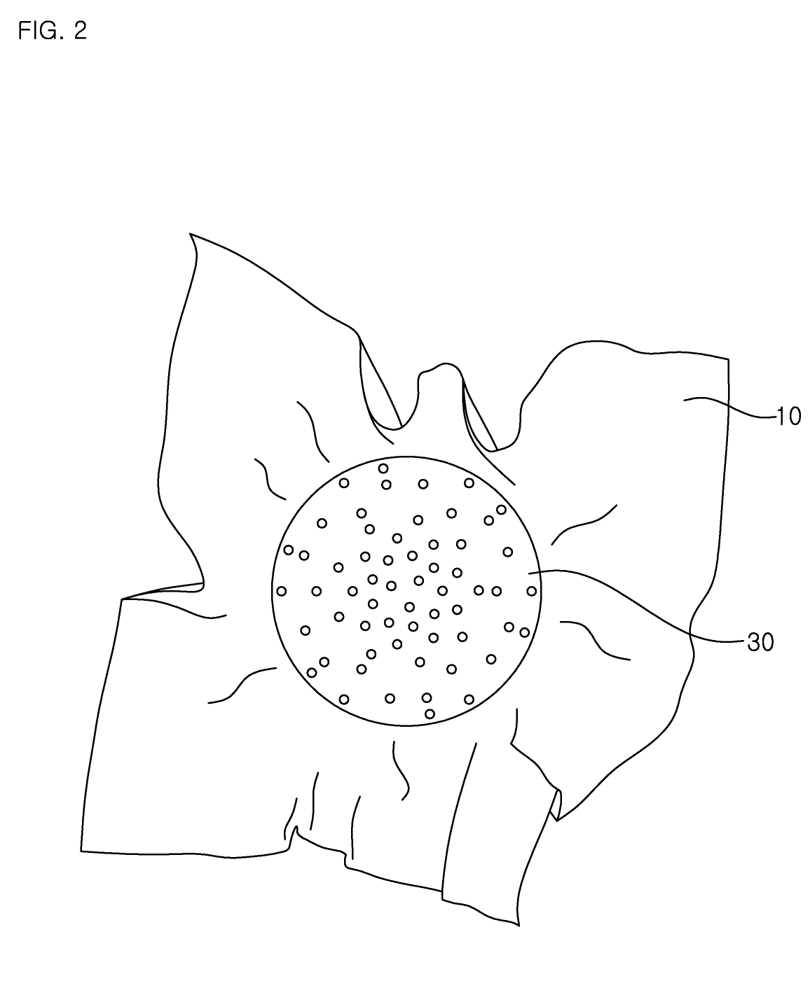

FIG. 1 shows a perspective view of the paper cookware 100 according to the present invention and FIG. 2 shows the induction interface disk 30 placed on the bottom 12 of the paper pot 10. The paper cookware 100 for use in induction heating includes a paper pot 10 made from a sheet to form a pot shape having a bottom portion 12 and a side portion 14 extending upwardly from the bottom portion 12; a support member 20, for structurally supporting the paper pot 10 to maintain the pot shape of the paper pot 10, having a bottom part 22 to support the bottom portion 12 of the paper pot 10 and the side part 24 extending upwardly from the bottom part 22 and supporting the side portion 14 of the paper pot 10; and an induction interface disk 30 placed on the bottom portion 12 of the paper pot 10 and made of a metal susceptible to being inductively heated with high frequency magnetic induction fields.

The paper pot 100 of the present invention is an induction cooker and induction cooking heats a cooking vessel with induction heating, instead of infrared radiation from electrical wires or a gas flame as with a traditional cooking stove. The paper pot 100 is especially suitable for cooking shabu shabu which is a Japanese dish featuring thinly sliced beef boiled in water. Shabu shabu cooking pot does not generally require a lid and a lid is not necessary for the paper pot 100 of the present invention. A lid may be included in the paper pot 100 for other types of cooking including shabu shabu, however.

Tn angle between the bottom part 22 and side part 24 of the support member 20 is an obtuse angel for supporting the side portion 14 of the paper pot 10 and preventing the side portion 14 from collapsing. Alternatively, the sectional view of the support member 20 is circular or oval and the major and minor axes gradually increase from the bottom end to the top.

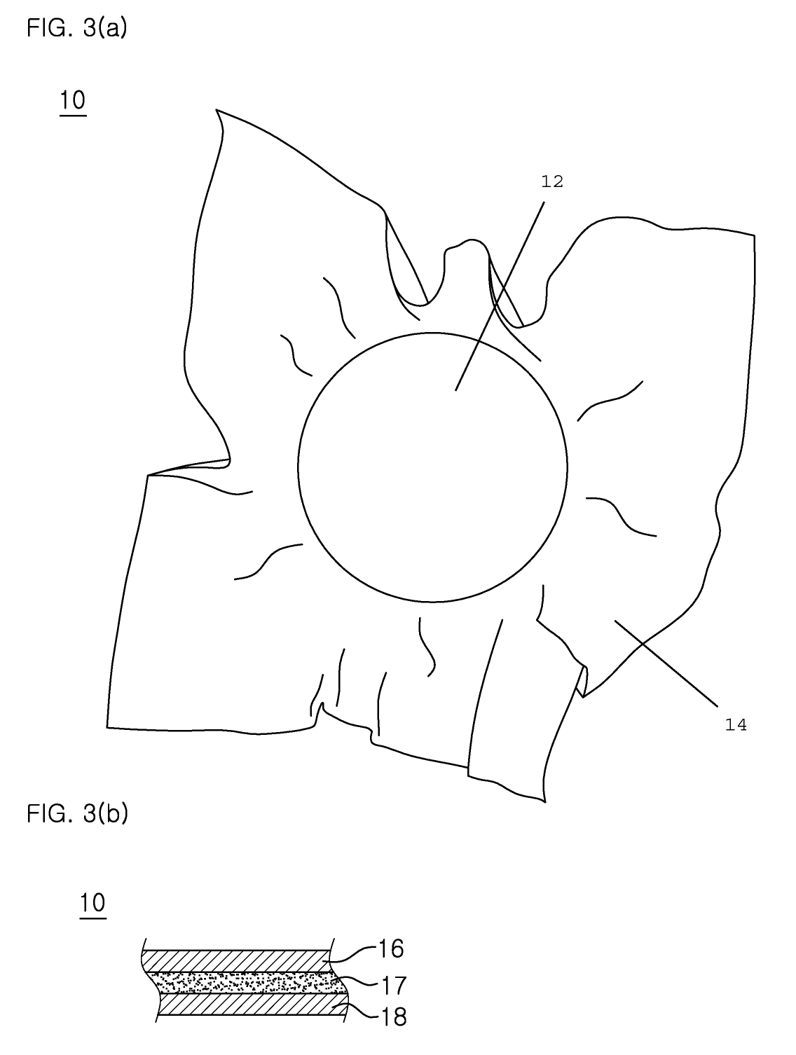

FIGS. 3(a) and 3(b) respectively show the paper pot and a sectional view of the sheet. The sheet is thin and flexible and it can be easily shaped into the paper pot 10. The sheet is made of synthetic paper. The sheet comprises a first outer layer 16, a second outer layer 18, and an inner layer 17 such that the inner layer 17 is located in between the first and second outer layers 16 and 18. At least one of the first outer layer 16, second outer layer 18, and inner layer 17 is impermeable to water or water proof.

Preferably, the inner layer 17 is impermeable to water or water proof. The inner layer 17 may be fabricated with silicone or water impermeable plastics. Alternatively, the first and second outer layers 16 and 18 are impermeable to water or water proof.

Alternatively, the first and second outer layers 16 and 18 are impermeable to water or water proof and the inner layer 17 is a flame retardative synthetic resin.

The paper cookware 100 is convenient to use because the paper pot 10 is disposable. Once the paper cookware 100 is used, the used paper pot 10 is disposed and a new one 10 is used. The supporting member 20 and the disk 30 are cleaned and used again.

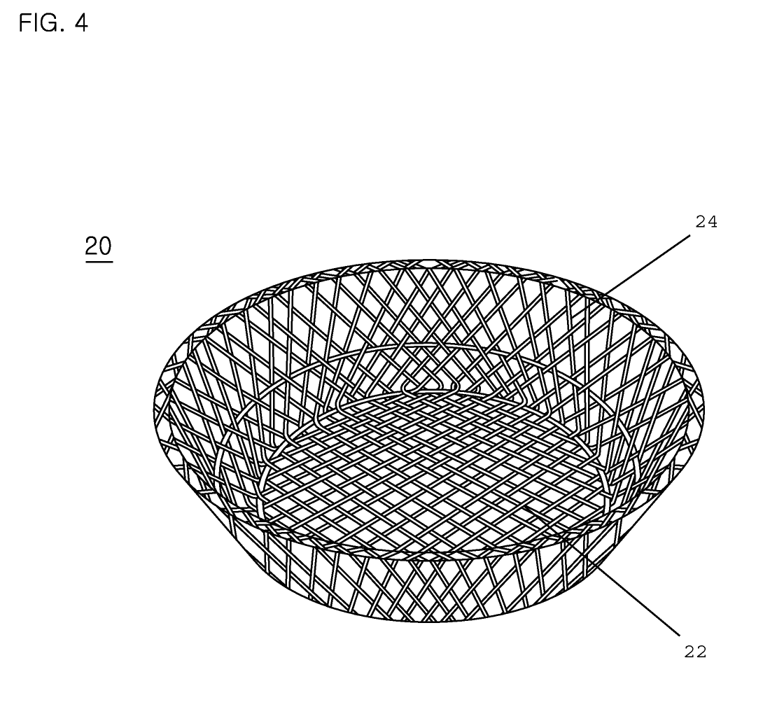

FIG. 4 shows a perspective view of the support member 20. The support member 20 is preferably constructed in a mesh structure as in FIG. 1. The support member 20 is made of a material which is thermally insulating and does not substantially reduce a field strength of the magnetic lines of flux acting on the induction interface disk 30. In addition, the support member 30 substantially blocks thermal conductivity. The material may be bamboo, polyimide or polycarbonate plastic high temperature foam.

FIG. 4 shows the support member 20 made of bamboo in a mesh structure. The bamboo is weaved to form the mesh structure. Bamboo is an insulating material which is substantially transparent to magnetic lines of flux.

The support member 30 may further have a suitable hardened high temperature outer surface of plastic, ceramic, or high temperature glass.

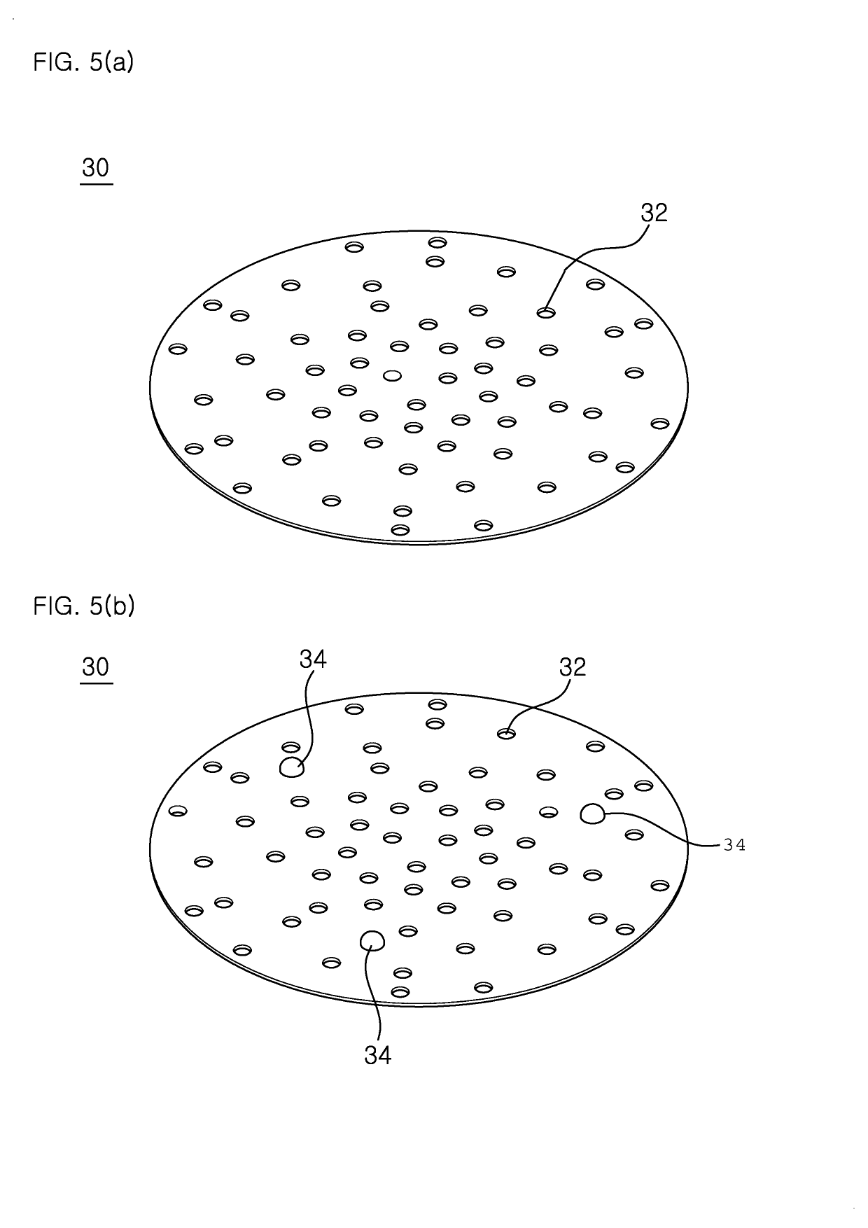

FIGS. 5(a) and 5(b) show top and bottom perspective views of the induction interface disk 30.

The induction interface disk 30 includes a plurality of holes 32. Without the holes, the induction interface disk 30 may float around the bottom portion 12 of the paper pot 10. The holes prevents such floating around of the disk 30. To further prevent the floating, the induction interface disk 30 may further include a plurality of spikes 34 formed on a bottom surface of the induction interface disk 30. The spikes 34 rest on the bottom portion 12 of the paper pot 10. Preferably, ends of the spikes are rounded not to make holes on the paper pot 10. The number of spikes 34 is preferably three.

The induction interface disk 30 is made of one or more ferromagnetic metal alloys susceptible to being inductively heated with high frequency magnetic induction fields. The induction interface disk 30 may be made of stainless steel, iron, titanium, or porcelainized iron or steel. Preferably, the induction interface disk 30 is made of stainless steel 430.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A paper cookware for use in induction heating, comprising:
a paper pot made from a sheet to form a pot shape having a bottom portion and a side portion extending upwardly from the bottom portion;
a support member, for structurally supporting the paper pot to maintain the pot shape of the paper pot, having a bottom part to support the bottom portion of the paper pot and the side part extending upwardly from the bottom part and supporting the side portion of the paper pot; and
an induction interface disk placed on the bottom portion of the paper pot and made of a metal susceptible to being inductively heated with high frequency magnetic induction fields.

2. The paper cookware of claim 1, wherein an angle between the bottom part and side part of the support member is an obtuse angel for supporting the side portion of the paper pot and preventing the side portion from collapsing.

3. The paper cookware of claim 1, wherein the sheet is made of synthetic paper.

4. The paper cookware of claim 1, wherein the sheet comprises a first outer layer, a second outer layer, and an inner layer wherein the inner layer is located in between the first and second outer layers.

5. The paper cookware of claim 4, wherein at least one of the first outer layer, second outer layer, and inner layer is impermeable to water or water proof.

6. The paper cookware of claim 5, wherein the inner layer is impermeable to water or water proof.

7. The paper cookware of claim 5, wherein the first and second outer layers are impermeable to water or water proof.

8. The paper cookware of claim 4, wherein the inner layer is fabricated with silicone or water impermeable plastics.

9. The paper cookware of claim 4, wherein the first and second outer layers are impermeable to water or water proof and the inner layer is a flame retardative synthetic resin.

10. The paper cookware of claim 1, wherein the support member is constructed in a mesh structure.

11. The paper cookware of claim 1, wherein the support member is made of a material which is thermally insulating and does not substantially reduce a field strength of magnetic lines of flux acting on the induction interface disk.

12. The paper cookware of claim 11, wherein the support member substantially blocks thermal conductivity.

13. The paper cookware of claim 11, wherein the material is bamboo, polyimide or polycarbonate plastic high temperature foam.

14. The paper cookware of claim 13, wherein the support member has a suitable hardened high temperature outer surface of plastic, ceramic, or high temperature glass.

15. The paper cookware of claim 1, wherein the induction interface disk comprises a plurality of holes.

16. The paper cookware of claim 15, wherein the induction interface disk further comprises a plurality of spikes formed on a bottom surface of the induction interface disk resting on the bottom portion of the paper pot.

17. The paper cookware of claim 16, wherein the number of spikes is three.

18. The paper cookware of claim 1, wherein the induction interface disk is made of one or more ferromagnetic metal alloys.

19. The paper cookware of claim 1, wherein the induction interface disk is made of stainless steel, iron, titanium, or porcelainized iron or steel.

20. The paper cookware of claim 1, wherein the induction interface disk is made of stainless steel 430.
